(19) United States
(12) Patent Application Publication
(10) Pub. No.: US 2025/0277394 A1
(43) Pub. Date: Sep. 4, 2025

(54) BAR LOCK ASSEMBLY

(71) Applicant: A.L. Hansen Manufacturing Co., Waukegan, IL (US)

(72) Inventor: William S. Hansen, III, Mettawa, IL (US)

(73) Assignee: A.L. Hansen Manufacturing Co., Waukegan, IL (US)

(21) Appl. No.: 19/062,669

(22) Filed: Feb. 25, 2025

Related U.S. Application Data
(60) Provisional application No. 63/559,594, filed on Feb. 29, 2024.

(51) Int. Cl. E05B 83/10

(52) U.S. Cl. CPC E05B 83/10

(57) ABSTRACT

A bar lock assembly includes a keeper having a base and a pair of laterally spaced side walls extending transversely from the base. At least one shaft extends between and is coupled to the side walls. A cam is coupled to and rotatable relative to the keeper between an engaged position and a disengaged position. The cam includes an engagement member engaged with the shaft when rotated to the engaged position. The engagement member is disengaged with the first shaft when rotated to the disengaged position. The cam may include a pair of engagement members. The keeper and/or cam may be roll formed and configured with a U-shaped cross-section.

### RELATED APPLICATION

This application claims priority to and the benefit of U.S. Provisional Patent Application No. 63/559,594, filed on Feb. 29, 2024, pending, the entirety of which is herein incorporated by reference.

### TECHNICAL FIELD

The present invention relates generally to a bar lock assembly, and in particular to a bar lock having a keeper and cam, and also to methods of assembling and use the bar lock assembly.

### BACKGROUND

Bar lock assemblies may be used for securing various components, such as trailer doors. The bar lock assemblies may include a keeper, a cam, an actuator shaft and a handle connected to the shaft. The handle may be manipulated to rotate the shaft and cam, thereby engaging the keeper and securing the component. Typically, the handle is configured to receive a lock to secure the bar lock assembly and component. The keeper and/or cam typically are made as die-cast parts, which are heavy, and relatively costly to manufacture and transport. Such parts also are not easily modified or capable of accommodating a locking device, such as a padlock. In addition, the handle, due an elevated positioning, may not be easily reached for receiving and manipulating the lock to secure the handle.

### SUMMARY

Briefly stated, in one aspect, one embodiment of a bar lock assembly includes a keeper having a base and a pair of laterally spaced side walls extending transversely from the base, wherein the side walls are configured with laterally aligned openings. First and second longitudinally spaced shafts extend between and are connected to the side walls on opposite sides of the openings. An actuator shaft is rotatable about a rotation axis aligned with the openings. A cam is coupled to and rotatable with the actuator shaft about the rotation axis between an engaged position and a disengaged position. The cam includes an engagement member engaged with the first shaft when rotated to the engaged position. The engagement member is disengaged with the first shaft when rotated to the disengaged position.

In another aspect, one embodiment of a bar lock assembly includes a U-shaped keeper having a base and a pair of laterally spaced side walls extending transversely from the base. A shaft extends between and is connected to the side walls. A U-shaped cam includes a base and a pair of laterally spaced side walls extending transversely from the base, wherein the U-shaped cam opens toward and is nested between the side walls of the U-shaped keeper. Each side wall of the cam includes an engagement member. The cam is rotatable about a rotation axis between an engaged position wherein the engagement members are engaged with the shaft and a disengaged position wherein the engagement members are disengaged from the shaft.

In other aspects, various embodiments of a method of manufacturing the bar lock assembly includes roll-forming a keeper from a piece of flat sheet metal, and/or roll forming a cam from a piece of flat sheet metal.

The various aspects and embodiments provide significant advantages over other bar lock assemblies, and methods for the use thereof. For example, and without limitation, the keeper and cam may be easily manufactured and assembled, and are lighter in weight than conventional component, without sacrificing strength or durability. In addition, the components, such as the cam, may be easily modified to accommodate a lock device, thereby providing for an alternative and more accessible system for securing the bar lock assembly and component, such as trailer door.

The present embodiments of the invention, together with further objects and advantages, will be best understood by reference to the following detailed description taken in conjunction with the accompanying drawings.

### BRIEF DESCRIPTION OF THE DRAWINGS

FIG. 1 is a rear view of a trailer having a door and a bar lock assembly.

FIG. 2 is a partially exploded perspective view of one embodiment of a bar lock assembly.

FIG. 3 is a plan view of one embodiment of a bar lock assembly.

FIG. 4 is a cross sectional view of the bar lock assembly taken alone line 4-4 in FIG. 3.

FIG. 5 is an end view of the bar lock assembly shown in FIG. 3.

FIG. 6 is a flat pattern for one embodiment of a keeper.

FIG. 7 is a perspective view of one embodiment of a keeper.

FIG. 8 is a side view of the keeper shown in FIG. 7.

FIG. 9 is a plan view of the keeper shown in FIG. 7.

FIG. 10 is an end view of the keeper shown in FIG. 7.

FIG. 11 is a flat pattern for one embodiment of a cam.

FIG. 12 is a perspective view of one embodiment of a cam.

FIG. 13 is a side view of the keeper shown in FIG. 12.

FIG. 14 is a plan view of the keeper shown in FIG. 12.

FIG. 15 is an end view of the keeper shown in FIG. 12.

### DETAILED DESCRIPTION OF THE PRESENTLY PREFERRED EMBODIMENTS

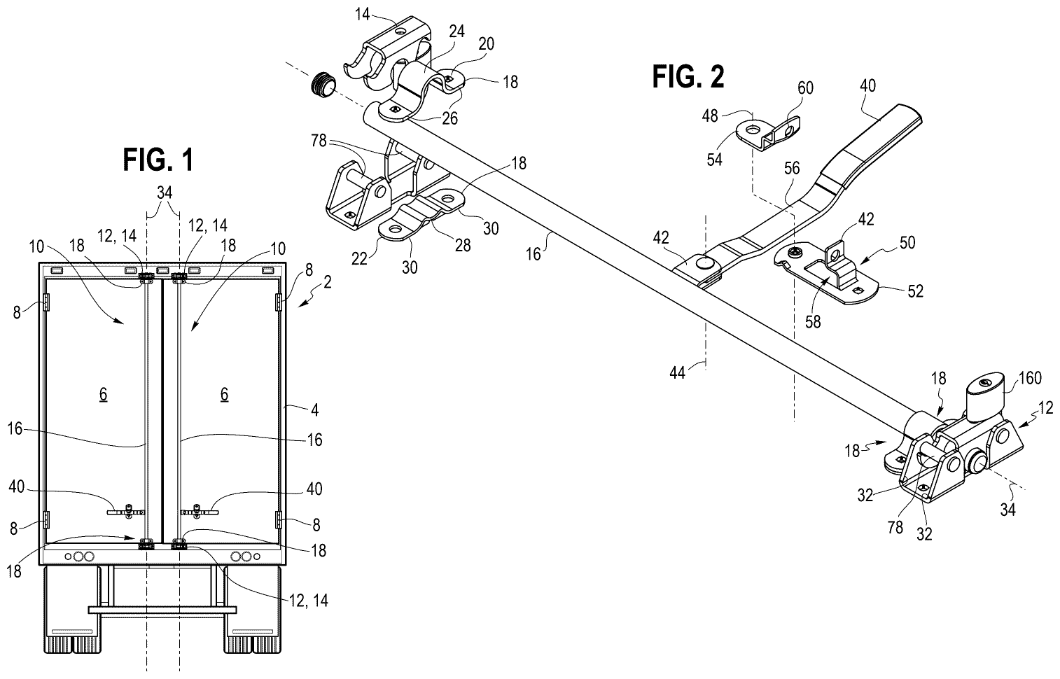

It should be understood that the term “plurality,” as used herein, means two or more. The term “coupled” means connected to or engaged with, whether directly or indirectly, for example with an intervening member, and does not require the engagement to be fixed or permanent, although it may be fixed or permanent. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components. The terms “upper,” “lower,” “rear,” “front,” “fore,” “aft,” “vertical,” “horizontal,” “right,” “left,” “inboard,” “outboard” and variations or derivatives thereof, refer to the orientations of an exemplary bar lock assembly and trailer, shown in FIG. 1, from the perspective of an operator facing the rear of the trailer.

Referring to FIG. 1, a trailer 2 is configured with a frame 4 hingedly supporting a pair of doors 6 with two pairs of hinges 8. The doors 6 may be rotated about axes defined by the hinges 8 between a closed position, wherein the doors 6 are closed over a doorway in the frame 4, and an open position. A bar lock assembly 10 is secured to each door 6 and the frame 4, and may be manipulated to secure the doors 6 to the frame 4 in the closed position, or to allow the doors 6 to be moved to the open position. It should be understood that the bar lock assemblies 10 may be used to secure other components, including other doors, and may be oriented vertically as shown in FIG. 1, horizontally, or in other orientations.

Referring to FIGS. 1 and 2, each bar lock assembly 10 includes at least one keeper 12 and at least one cam 14. As shown in FIGS. 1 and 2, each bar lock assembly 10 include a pair of keepers 12 and a pair of cams 14, but it should be understood that a single keeper 12 and cam 14 may suffice in certain applications. The bar lock assembly 10 further includes an actuator shaft 16, which may be rotatably secured to the door 6 with a pair of longitudinally spaced bearing plate assemblies 18. The bearing plate assembly 18 includes an upper bearing plate 20 having a C-shaped bearing component 24 defining a cavity and a pair of end flanges 26, and a lower bearing plate 22 having a curved support component 28 and a pair of end flanges 30. The upper and lower bearing plates 20, 22 are sandwiched about the actuator shaft 16, with the end flanges 26, 30 being aligned and secured to the door 6 with fasteners 32, such bolts. The actuator shaft 16 rotates in the bearing plate assemblies 18 about a rotation axis 34. A handle 40 is rotatably secured to the actuator shaft 16 between the bearing plate assemblies 18. The handle 40 is rotatably coupled to a clevis 42 fixedly (i.e., non-rotatably) secured to the shaft 16, for example by welding. The clevis 42 defines a rotation axis 44 orthogonal to the rotation axis 34 of the shaft 16. The handle 40 may be rotated about the axis 44, but also grasped to rotate the shaft 16 about the rotation axis 34. A locking assembly 50 includes a seal base plate 52, which may be secured to one of the doors 6, and a seal pivot 54 pivotally secured to the seal base plate 52 and door, for example with shaft, about a pivot axis 48. The seal pivot 54 may be pivoted to allow a shank 56 of the handle 40 to be rotated into alignment with a slot 58 defined by the base plate 52, and then rotated into the slot 58, with the seal pivot 54 thereafter being pivoted over the shank 56. A lock or other seal, such as a custom's loop, may be secured through openings in aligned flanges 60, 62 of the seal pivot 54 and seal base plate respectively.

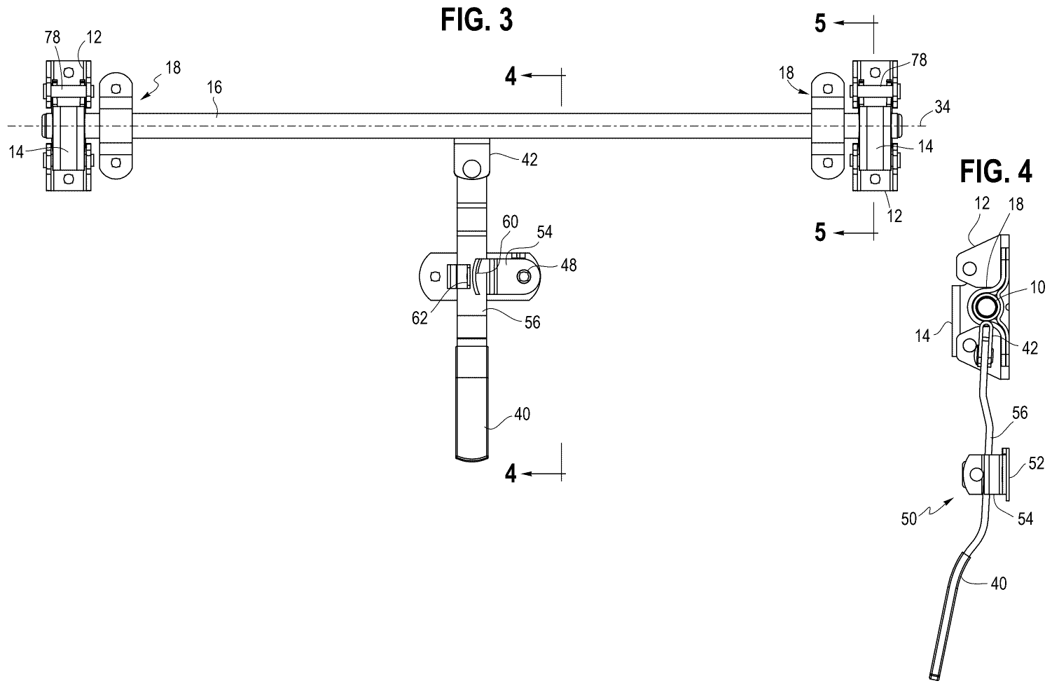

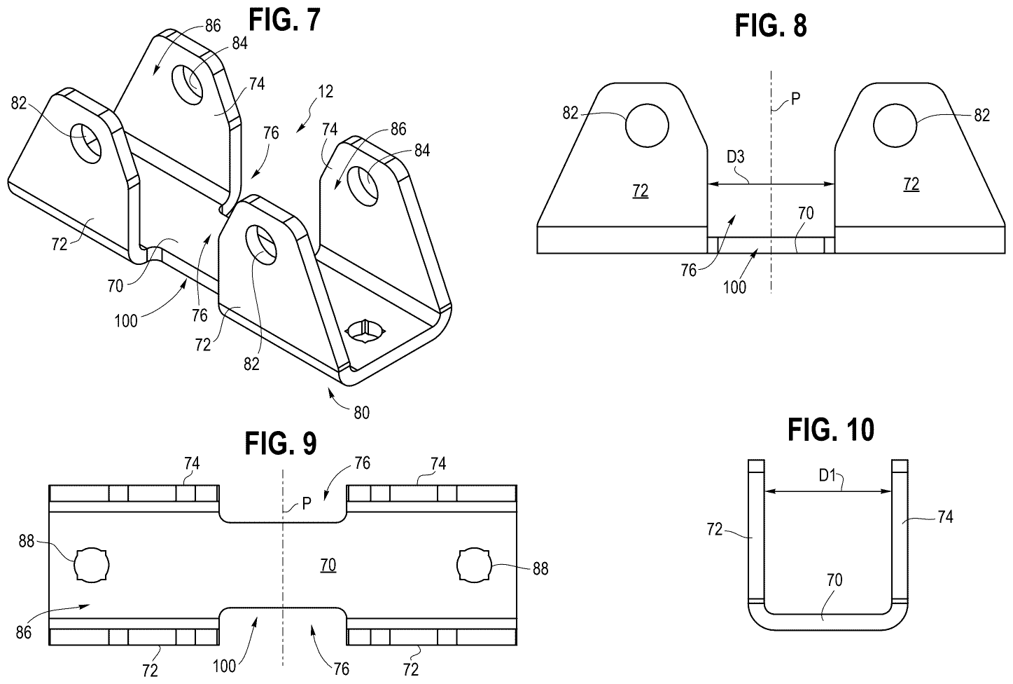

Referring to FIGS. 2, 3, 5 and 7-10, each keeper 12 includes a shell 80 having a base 70 and a pair of laterally spaced side walls 72, 74 extending transversely from the base 70. In one embodiment, the side walls 72, 74 are orthogonal to the base 70. Each of the side walls 72, 74 includes or defines laterally aligned openings 76. In one embodiment, each side wall 72, 74 includes a pair of flanges that are longitudinally spaced apart a distance D3 to define the openings 76. The keeper 12 further includes first and second longitudinally spaced shafts 78 extending between and connected to the side walls 72, 74 on opposite sides of the openings 76. In one embodiment, each shaft 78 extends through aligned openings 82, 84 in the side walls 72, 74, with the shafts 78 being secured to the side walls 72, 74, for example by welding, or with fasteners such as nuts or other adhesives. The actuator shaft 16 is aligned with, and extends through the openings 76 in the side walls 72, 74. The side walls 72, 74 are spaced apart a distance D1, and define a mouth 86 opening outwardly from the base 70. The base 70 includes one or more mounting features 88, shown as openings shaped to receive fasteners, such as bolts, such that the base 70 may be secured to the frame 4. The keeper 12 is symmetrical about a center plane P, and is therefore not “handed,” and may be installed at either end of the bar lock assembly 10 without needing to orient the keeper 12.

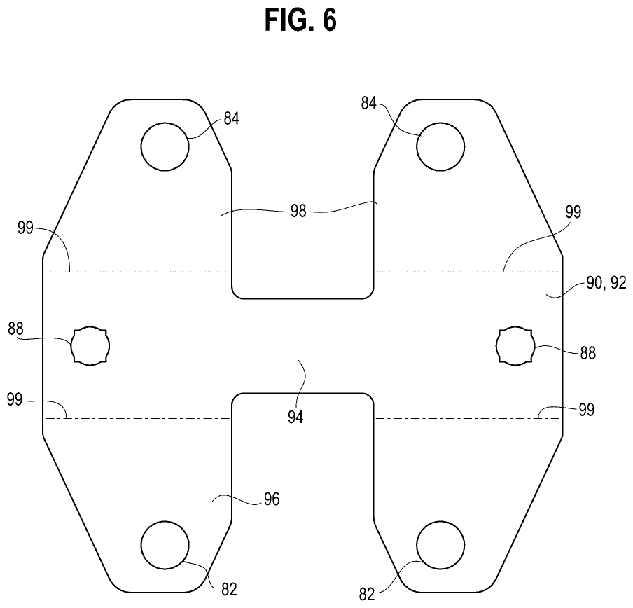

Referring to FIG. 6, the keeper 12 may be roll formed from a flat sheet 90 of metal, having a flat pattern 92. In one embodiment, the flat pattern 92 has an H-shape, with a center portion 94 and opposite pairs of flanges 96, 98 that may be bent transverse to the center portion 94 by roll forming along bend lines 99, or other known manufacturing systems, such that the flanges 96, 98 define the side walls 72, 74 and the keeper shell 80 has a U-shape when viewed from the end. The various openings 82, 84, 88 may be formed, for example by drilling, in the flat sheet 90 before forming the shell 80. As shown in FIGS. 6 and 9, a relief 100 may be provided on opposite sides of the center portion 94, or base 70, to promote the forming of the side walls 72, 74. In another embodiment, the side walls may be continuous, with the openings 76, 82, 84 drilled or otherwise machined into the side walls. In various embodiments, the flat sheet 90 of metal may be made of steel, aluminum or other suitable materials.

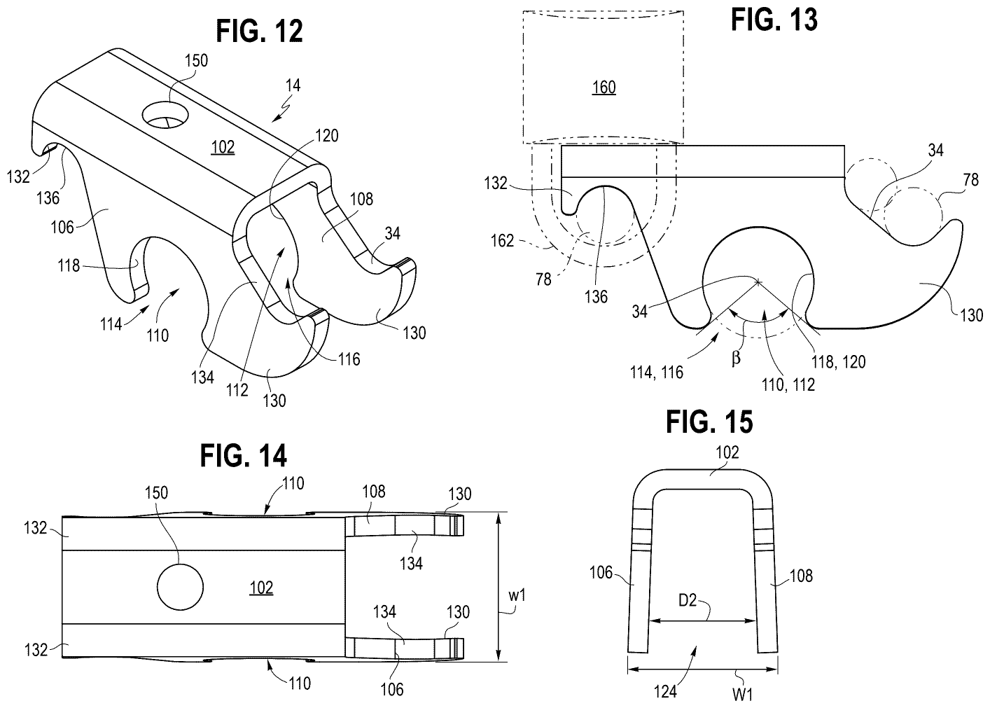

Referring to FIGS. 2, 3, 5 and 12-15, each cam 14 includes a base 102 and a pair of laterally spaced side walls 106, 108 extending transversely from the base 102. Each of the side walls 106, 108 includes or defines laterally aligned openings 110, 112. In one embodiment, each opening 110, 112 is configured with a mouth 114, 116 and an inner peripheral surface 118, 120, which extends less than 300 degrees around a center axis 34, the inner periphery 118, 120 of the openings 110, 112 and the exterior surface of the actuator shaft 16, which is disposed in the openings 110, 112 and secured thereto, for example by welding. Put another way, the openings 110, 112 define a sector, with β defining the minor sector. In various embodiments, β<300 degrees, and may be less than or equal to 270 degrees. The side walls 106, 108 are spaced apart a distance D2, with a maximum outer, or exterior, width W1 of the cam 14 being less than the interior width D1 of the keeper 12, such that the cam 14 may be nested in the keeper 12 between the side walls 72, 74. The side walls 106, 108 define a mouth 124 opening outwardly from the base 102. In this way, the U-shaped cam 14 opens toward the base 70, and is nested between the side walls 72, 74, of the U-shaped keeper 12.

The cam 14 is coupled to and rotatable with the actuator shaft 16 about the rotation axis 34 between an engaged position and a disengaged position. The cam 14 includes first and second engagement members 130, 132 at opposite ends of each side walls 72, 74. The first engagement member 130 is configured with an engagement surface 134. The engagement member 130 has an end hook defining a cavity opening towards the base 102 and away from the mouth 124. The surface 134 has a flat portion and a curved end that is shaped to engage the shaft 78. The second engagement member 132 is also configured with an engagement surface 136, and includes an end hook defining a cavity opening away from the base 102, in an opposite direction than the first cavity. In operation, as the cam 14 is rotated, the first engagement member 130 is rotated under the first shaft 78 which slides along the surface until the shaft 78 is engaged by the hook of the first engagement member 130. At the same time, the second engagement member 132 rotates over the second shaft 78 and is engaged therewith to prevent rattling. It should be understood that the second engagement member 132, and second shaft 78, may be omitted in one embodiment. Even if the cam 14 is configured with only one engagement member, the cam may still be used with a keeper 12 having two shafts 78, such that the orientation of the keeper need not be determined before installation. It should also be understood that the cam may be configured with a single side wall, having only a first engagement member, or with first and second engagement members.

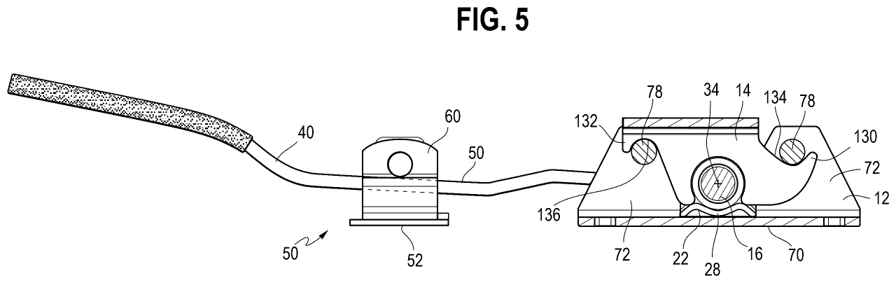

In operation, the cam 14 is rotated with the actuator shaft 16 through manipulation of the handle 40 between an engaged position, wherein the first engagement member 130 is engaged with the first shaft 78 and the second engagement member 132 is engaged with the second shaft 78, and a disengaged position, wherein the first and second engagement members 130, 132 are disengaged with the first and second shafts 78 respectively. As shown in FIG. 5, the first engagement member 130 is disposed under the first shaft 78 and the second engagement member 132 is disposed over the second shaft 78 when the cam 14 is in the engaged position. As further referenced below, a locking device 160 may be used to secure the cam 14 to the keeper 12 to lock the bar assembly in the engaged position.

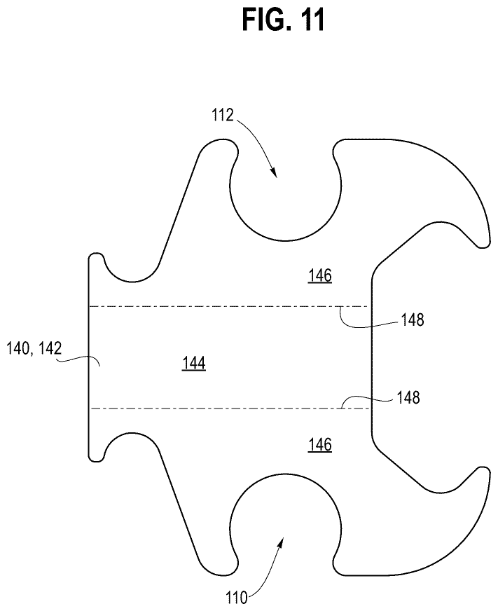

Referring to FIG. 11, the cam 14 may be roll formed from a flat sheet 140 of metal, having a flat pattern 142. In one embodiment, the flat pattern 142 has a center portion 144 and opposite pairs of flanges 146 that may be bent transverse to the center portion by roll forming along bend lines 148, or other known manufacturing systems, such that the flanges 146 define the side walls 106, 108 and the cam has a U-shape when viewed from the end. In one embodiment, the side walls 106, 108 are not bent or formed to 90 degrees with the base, but rather are angled slightly outwardly at an angle α greater than 90 degrees, for example and without limitation 92 degrees. The various openings 110, 112, and engagement surfaces 134, 136 may be formed, for example by machining (e.g., laser cutting), drilling or other known manufacturing techniques, in the flat sheet 140 before forming the cam 14. In various embodiments, the flat sheet 140 of metal may be made of steel or aluminum, or other suitable materials. Due to the unique shape of the cam 14, and openings 110, 112, the actuator shaft 16 may be welded to the cam in a single welding operation, with the cam and/or welder being rotated less than 300 degrees, for example less than or equal to 270 degrees. In this way, the overall manufacturing process is greatly simplified.

Referring to FIGS. 2, 12 and 14, the cam 14 includes a lock receiving opening 150 formed in the base 102 between the first and second engagement members 130, 132. As shown in FIG. 2, the lock receiving opening 150 is positioned and configured to receive a locking member 160 when the engaged position. Specifically, a shackle 162 of the lock, e.g., padlock, may be disposed through the lock receiving opening 150 and around one of the shafts 78 of the keeper 12 located proximate the lock receiving opening 150. In this way, the bar lock assembly 10 may be secured locally in a locked configuration, without the need for the operator to access the handle 40 and locking assembly 50, which may be elevated. A seal, or other anti-tampering device such as a zip tie, may also be secured through the receiving opening 150 and around one of the shafts 78 so as prevent and reveal any tampering.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A bar lock assembly comprising:
a keeper comprising:
a base;
a pair of laterally spaced side walls extending transversely from the base, wherein the side walls comprise laterally aligned openings; and
first and second longitudinally spaced shafts extending between and connected to the side walls on opposite sides of the openings;
an actuator shaft rotatable about a rotation axis aligned with the openings; and
a cam coupled to and rotatable with the actuator shaft about the rotation axis between an engaged position and a disengaged position, wherein the cam comprises an engagement member engaged with the first shaft when rotated to the engaged position and wherein the engagement member is disengaged with the first shaft when rotated to the disengaged position.

2. The bar lock assembly of claim 1 wherein the engagement member comprises a first engagement member engaged with the first shaft when the cam is in the engaged position and disengaged from the first shaft when the cam is in the disengaged position, and further comprising a second engagement member engaged with the second shaft when the cam is rotated to the engaged position and wherein the second engagement member is disengaged with the second shaft when the cam is rotated to the disengaged position.

3. The bar lock assembly of claim 2 wherein the first engagement member is disposed under the first shaft and the second engagement member is disposed over the second shaft when the cam is in the engaged position.

4. The bar lock assembly of claim 2 wherein the cam comprises a base and a pair of a pair of laterally spaced side walls extending transversely from the base, wherein each side wall comprises the first and second engagement members.

5. The bar lock assembly of claim 4 wherein the side walls of the cam comprise laterally aligned openings, wherein the actuator shaft is disposed in the openings in the side walls of the cam.

6. The bar lock assembly of claim 5 wherein actuator shaft is welded to the side walls of the cam, wherein a weld connecting the actuator shaft and one of the side walls extends less than 300 degrees around the periphery of the actuator shaft.

7. The bar lock assembly of claim 4 wherein an exterior width of the cam between outer surfaces of the side walls of the cam is less than an interior width of the keeper between the inner surfaces of the side walls of the keeper.

8. The bar lock assembly of claim 4 wherein the cam comprises a lock receiving opening formed in the base between the first and second engagement members, wherein the lock receiving opening is positioned and configured to receive a locking member.

9. The bar lock assembly of claim 8 further comprising a lock comprising a shackle disposed through the lock receiving opening and around one of the shafts located proximate the lock receiving member.

10. The bar lock assembly of claim 2 wherein the first and second engagement members comprises first and second hooks with first and second engagement surfaces facing opposite directions.

11. A method of manufacturing the bar lock assembly of claim 1 comprising roll-forming the keeper from a piece of flat sheet metal.

12. The method of claim 11 wherein the cam comprises a U-shaped cross section, and further comprising roll-forming the cam from a piece of flat sheet metal.

13. A bar lock assembly comprising:
a U-shaped keeper comprising a base, a pair of laterally spaced side walls extending transversely from the base, and a shaft extending between and connected to the side walls, and
a U-shaped cam comprising a base and a pair of laterally spaced side walls extending transversely from the base, wherein the U-shaped cam opens toward and is nested between the side walls of the U-shaped keeper, wherein each side wall of the cam comprises an engagement member, wherein the cam is rotatable about a rotation axis between an engaged position wherein the engagement members are engaged with the shaft and a disengaged position wherein the engagement members are disengaged from the shaft.

14. The bar lock assembly of claim 13 wherein the shaft comprises a first shaft, and further comprising a second shaft longitudinally spaced from the first shaft, wherein the second shaft extends between and is connected to the side walls, and wherein the engagement members comprises first engagement members, and wherein each side wall of the cam further comprises a second engagement member engaged with the second shaft when the cam is rotated to the engaged position and wherein the second engagement member is disengaged with the second shaft when the cam is rotated to the disengaged position.

15. The bar lock assembly of claim 14 wherein the first engagement members are disposed under the first shaft and the second engagement members are disposed over the second shaft when the cam is in the engaged position.

16. The bar lock assembly of claim 13 wherein the side walls of the cam comprise laterally aligned openings, and further comprising an actuator shaft disposed in the openings in the side walls of the cam, wherein the actuator shaft defines the rotation axis.

17. The bar lock assembly of claim 16 wherein the actuator shaft is welded to the side walls of the cam, wherein a weld connecting the actuator shaft and one of the side walls extends less than 300 degrees around the periphery of the actuator shaft.

18. The bar lock assembly of claim 13 wherein the cam comprises a lock receiving opening formed in the base, wherein the lock receiving opening is positioned and configured to receive a locking member.

19. The bar lock assembly of claim 18 further comprising a lock comprising a shackle disposed through the lock receiving opening and around the shaft.

20. The bar lock assembly of claim 14 wherein the first and second engagement members comprises first and second hooks with first and second engagement surfaces facing opposite directions.
